(19) United States
(12) Patent Application Publication
(10) Pub. No.: US 2025/0182423 A1
(43) Pub. Date: Jun. 5, 2025

(54) Spatial Interface For Multi-Modal Artificial Intelligence Model

(71) Applicant: Google LLC, Mountain View, CA (US)

(72) Inventors: Daniel Motzenbecker, Brooklyn, NY (US); Alexander Chen, Carlisle, MA (US); Jackson Lynch, Brooklyn, NY (US)

(21) Appl. No.: 18/944,836

(22) Filed: Nov. 12, 2024

Related U.S. Application Data
(60) Provisional application No. 63/606,800, filed on Dec. 6, 2023.
(60) Provisional application No. 63/605,851, filed on Dec. 4, 2023.

(51) Int. Cl. G06T 19/20

(52) U.S. Cl. CPC G06T 19/20; G06T 2219/2004; G06T 2219/2016

(57) ABSTRACT

The technology described herein is directed to spatial interface for multi-modal input to artificial intelligence (AI) powered tools. The interface allows for a first mode of input, such as selection of one or more objects using a movable window that can be resized and reshaped by a user. In addition, the interface allows for a second mode of input, such as text or voice commands. The AI powered tools accept the inputs from the first and second modes and dynamically generates a response.

### CROSS-REFERENCE TO RELATED APPLICATIONS

This application claims the benefit under 35 U.S.C. § 119(e) of the filing date of U.S. Patent Application No. 63/605,851 filed on Dec. 4, 2023, and U.S. Patent Application No. 63/606,800 filed on Dec. 6, 2023, for SPATIAL INTERFACE FOR MULTI-MODAL ARTIFICIAL INTELLIGENCE MODEL, both of which are incorporated herein by reference.

### BACKGROUND

An artificial intelligence model uses data to recognize patterns and make decisions. The models can be trained using a variety of techniques, such as supervised learning, unsupervised learning, semi-supervised learning, reinforcement learning, etc. The artificial intelligence models can be trained using an initial set of input data, referred to as training data, and executed using an input referred to as a prompt or inference data. Typically, input to artificial intelligence models is one dimensional, such as a string of typed or spoken text, or selection of a single image. Accordingly, the artificial intelligence models are limited to specific types of input that can be ingested in a limited way. As a result, ingesting multiple prompts is performed individually in a sequence, thereby requiring significant time and processing power.

### BRIEF SUMMARY

The technology described herein is directed to spatial interface for multi-modal input to artificial intelligence (AI) powered tools. The interface allows for a first mode of input, such as selection of one or more objects using a movable window that can be resized and reshaped by a user. In addition, the interface allows for a second mode of input, such as text or voice commands. The AI powered tools accept the inputs from the first and second modes and dynamically generate a response.

One aspect of the disclosure provides a method, comprising receiving, at one or more processors through a spatial interface displaying a first offering of objects, user input selecting a window size and shape, such that the window encompasses one or more objects depicted on the spatial interface; receiving, at the one or more processors, a second mode of input; providing the one or more objects and the second mode of input as a combined input to an artificial intelligence model; determining, by the artificial intelligence model, at least one relationship between the one or more objects and the second mode of input; and generating, by the artificial intelligence model, a response based on the at least one relationship.

According to some examples, the method further includes outputting the response visually through the spatial interface.

According to some examples, the one or more objects comprise a first object of a first type and a second object of a second type different from the first type. For example, the first object may be an image.

According to some examples, the method may include rasterizing the one or more objects encompassed in the window.

According to some examples, the second mode of input may be text or verbal input. The second mode of input may be received through the spatial interface. In other examples, the second mode of input may be received through a second interface separate from the spatial interface.

The window may encompass multiple objects, and determining the at least one relationship may include identifying a relationship among the multiple objects.

According to some examples, the method may further include receiving through the spatial interface a manipulation input; and adjusting, by the one or more processors, the spatial interface in response to the manipulation input, the adjusting comprising panning or zooming the spatial interface to display a second offering of objects different from the first offering of objects.

According to some examples, the method may include receiving input adjusting a location of a first object of the first offering of objects relative to a second object of the first offering of objects.

According to some examples, the method may include adding an object to the first offering of objects.

Another aspect of the disclosure provides a system, comprising: memory; and one or more processors in communication with the memory, the one or more processors configured to: receive, through a spatial interface displaying a first offering of objects, user input selecting a window size and shape, such that the window encompasses one or more objects depicted on the spatial interface; receive a second mode of input; provide the one or more objects and the second mode of input as a combined input to an artificial intelligence model; determine, using the artificial intelligence model, at least one relationship between the one or more objects and the second mode of input; and generate, using the artificial intelligence model, a response based on the at least one relationship.

According to some examples, the one or more processors may be configured to output the response visually through the spatial interface. The one or more objects may include an image.

According to some examples, the one or more processors may be configured to rasterize the one or more objects encompassed in the window. The second mode of input may be text or verbal input. The window may encompass multiple objects, and determining the at least one relationship may include identifying a relationship among the multiple objects.

According to some examples, the one or more processors may be configured to receive through the spatial interface a manipulation input; and adjust the spatial interface in response to the manipulation input, the adjusting comprising panning or zooming the spatial interface to display a second offering of objects different from the first offering of objects.

Yet another aspect of the disclosure provides a non-transitory computer-readable medium storing instructions executable by one or more processors for performing a method, comprising: receiving, through a spatial interface displaying a first offering of objects, user input selecting a window size and shape, such that the window encompasses one or more objects depicted on the spatial interface; receiving a second mode of input; providing the one or more objects and the second mode of input as a combined input to an artificial intelligence model; determining, by the artificial intelligence model, at least one relationship between the one or more objects and the second mode of input; and generating, by the artificial intelligence model, a response based on the at least one relationship.

### BRIEF DESCRIPTION OF THE DRAWINGS

FIGS. 1A-1E illustrate examples of manipulating a spatial interface, in accordance with aspects of the disclosure.

FIGS. 2A-2C illustrate examples of AI-generated responses to multi-modal input using the spatial interface, in accordance with aspects of the disclosure.

FIG. 3 is a block diagram of an image analysis system, in accordance with aspects of the disclosure.

FIG. 4 is a block diagram of an example system for implementing aspects of the technology described herein.

FIG. 5 is a block diagram of an example environment for implementing engines within a datacenter, according to aspects of the disclosure.

FIG. 6 is a flow diagram of an example process for providing AI-generated responses to multi-modal input through the spatial interface, according to aspects of the disclosure.

### DETAILED DESCRIPTION

This technology generally relates to a spatial interface for multi-modal input to artificial intelligence (“AI”) models. The interface provides an expansive canvas of which a portion is visible in a display at a given time. The canvas can be panned in any direction or zoomed to adjust the visible portion. Any number of images or other objects can be arranged on the canvas, and rearranged per user input. The image or objects can include, for example, photos, videos, graphics, illustrations, emojis, blocks of text or code, audio files, or any other types of media or objects. It should be understood that the spatial interface can include any combination of various types of objects or files. For example, combinations of images, videos, and audio may be selected together as input to the AI model at a given time. While some objects may be visible in a first display area, a different set of objects may be visible in a second display area after manipulating the canvas. A selection window allows for two-dimensional input in relation to the images on the canvas. The window can be resized and reshaped by the user, and can be moved to any portion of the canvas. The selection window may be sized to include a specific portion of an image, an entire image, or multiple images or other objects on the canvas. Such images are flattened or rasterized and input to the AI models. The interface may also include a second input, such as a field for text entry or voice commands. The second input may be provided to the AI model along with the images selected using the selection window. In this regard, the AI model can process the input in combination. For example, if the user selects multiple images in the selection window and enters a text input such as “what are the similarities between these two images” the AI model may process the two inputs in conjunction and return a response. For example, the response may highlight the visual similarities in the images using annotations, may explain using text or audio what the visual similarities are, etc.

The technology described herein includes techniques for enabling artificial intelligence to ingest multimodal input and provide responses based on each of the multiple modes of input. In some implementations, the techniques disclosed herein enable artificial intelligence to simultaneously receive and dynamically analyze multiple different types of input, including two-dimensional visual input. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images/video, text, audio, or other content, in response to input prompts or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

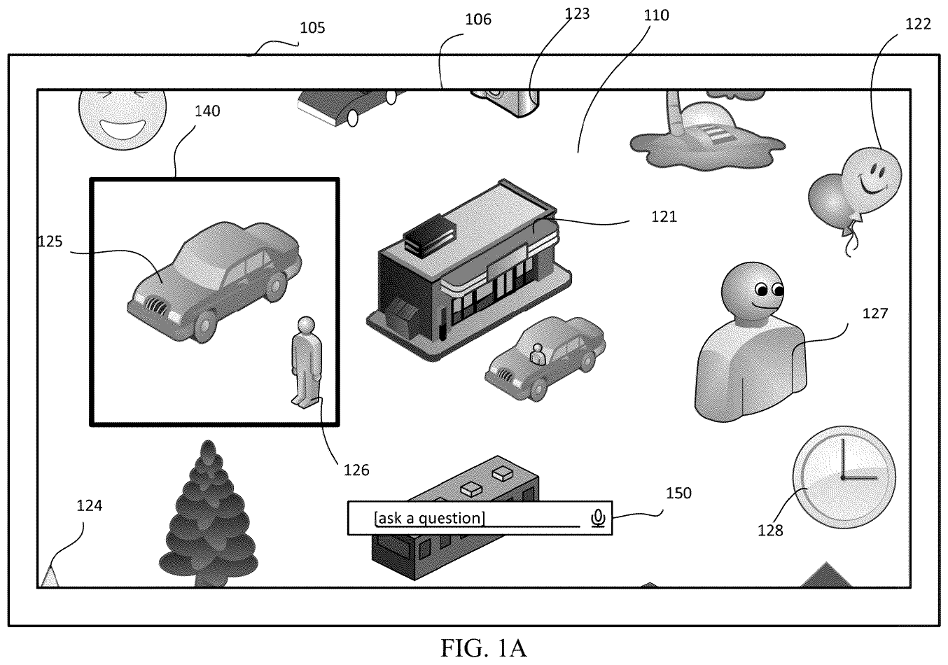

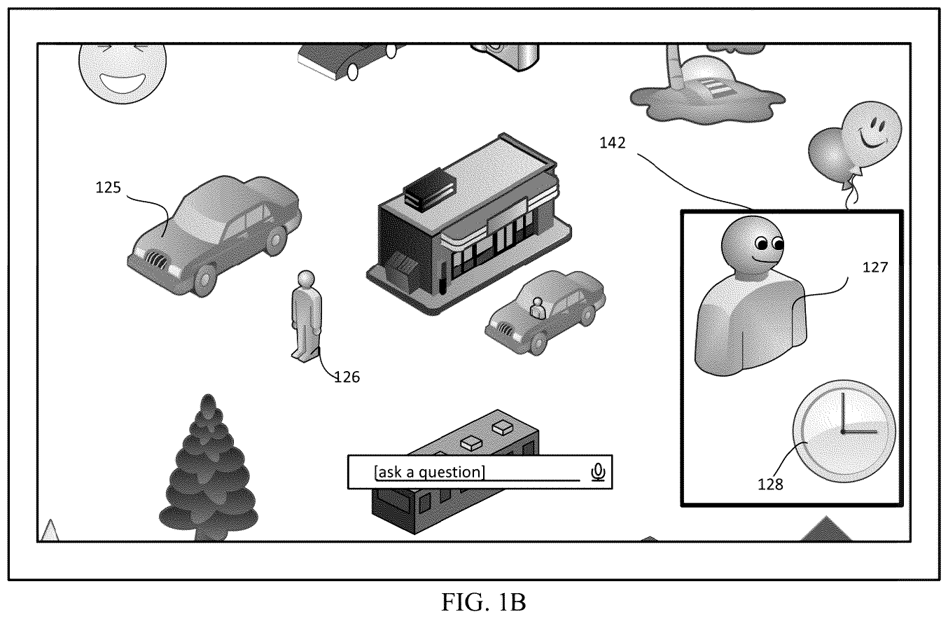

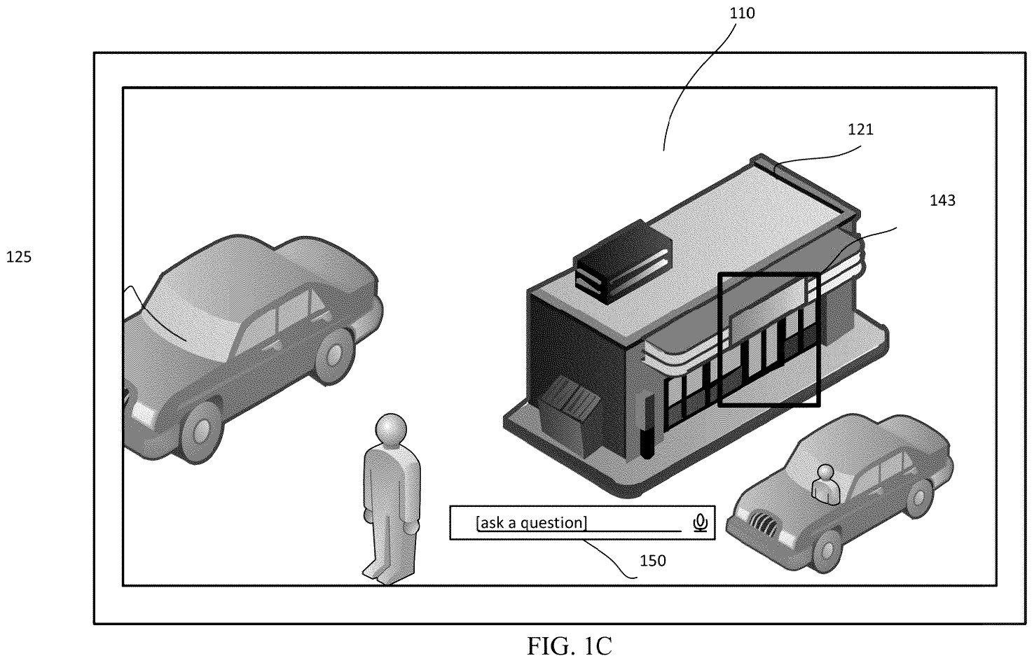

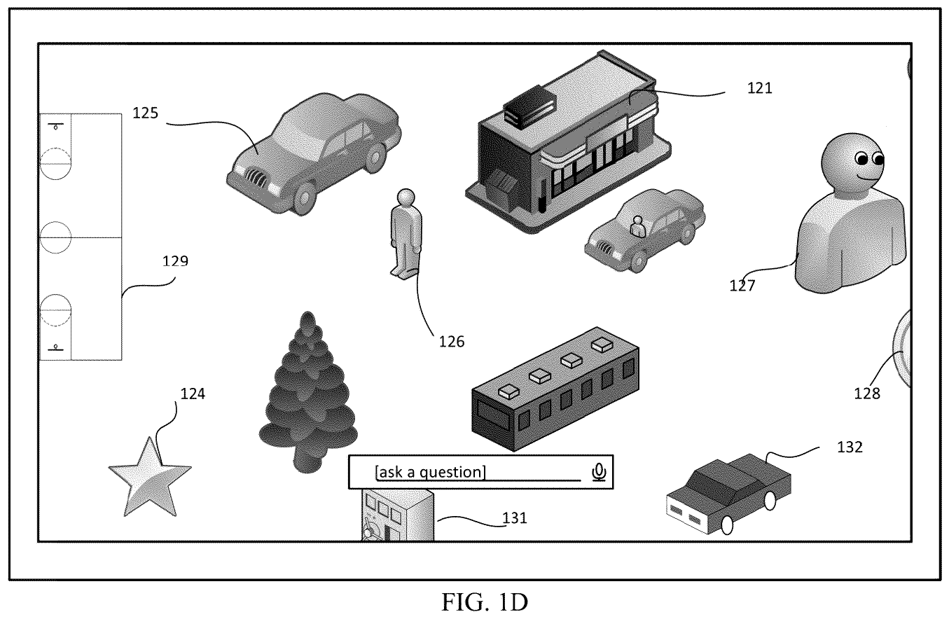

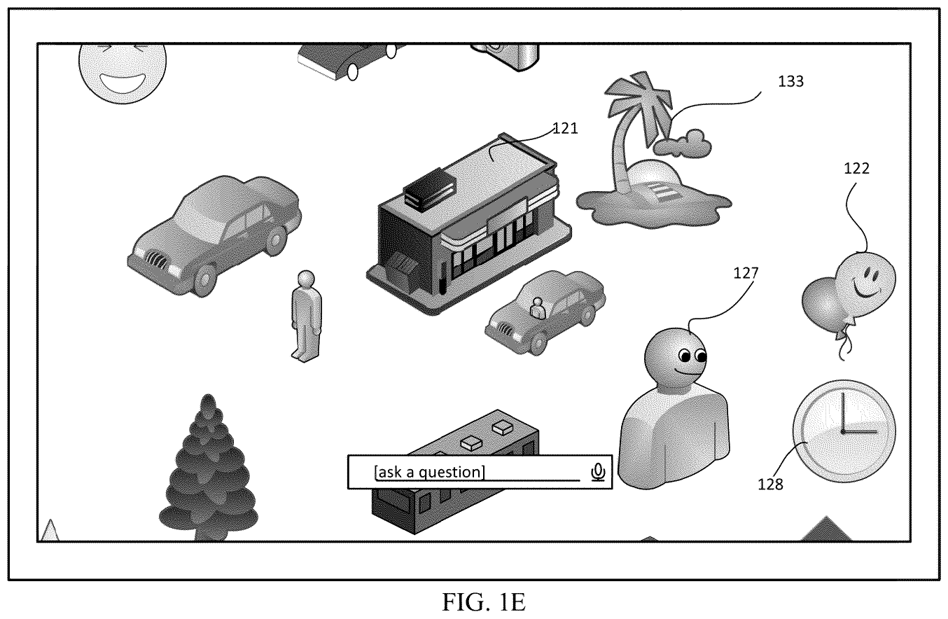

FIGS. 1A-1E illustrate examples of a spatial interface during various stages of manipulation. As shown in FIG. 1A, a display 105 has a viewable area 106 which depicts spatial interface 110. The spatial interface 110 may include a canvas that extends beyond the viewable area 106. The canvas may be significantly larger than the viewable area 106, or it may be infinite. The canvas may have a plurality of images 121, 122, 123, 124, 125, 126, 127, 128, etc. thereon. The images may be placed on the canvas by user input, such as copy/paste, downloads, etc. In other examples, the images may be placed on the canvas by the AI tool, such as in response to a query of “show me a car.”

The interface 110 may further include a first input mode, such as an adjustable window 140. The window may be moved, resized, reshaped, or otherwise manipulated by a user to select particular objects or images within the window 140. In the example of FIG. 1A, the window 140 is sized and shaped to encompass images of car 125 and person 126. The images or objects selected using the window 140 may be dynamically input to the AI tool. For example, as soon as the window 140 is manipulated to encompass new images or objects, those images or objects may be input to the AI tool.

In some examples, image processing may be performed dynamically as part of the process of selecting and inputting the images to the AI model. Examples of such processing may include flattening or rasterizing the images. For example, with reference to FIG. 1A, when the window 140 is formed around images of car 125 and person 126, pixels of each image may be merged into one two-dimensional input frame.

The interface 110 may further include a second input mode, such as text input 150. Text input 150 may be populated using keyboard input, voice commands, or any other form of text input. In this regard, a user may input information or queries related to the first input mode. For example, when the window 140 includes the car 125 and the person 126, the user may enter text input asking the AI tool to change the colors of both images from blue to red.

While interface and window are shown as two-dimensional in FIG. 1A, in other examples the interface, selection window, or both can be formed in additional dimensions, such as three dimensional (3D).

The window 140 of FIG. 1A can be resized, reshaped, and repositioned to select different images or objects within the spatial interface 110. As shown in FIG. 1B, window 142 has a different size, shape, and position than the window 140 of FIG. 1A. The window 142 also includes different objects as compared to the window 140 of FIG. 1A. As shown, the window 142 of FIG. 1B includes person 127 and clock 128. It should be understood that in other examples the window 142 may be drawn around any of the objects in the spatial interface 110. Moreover, while the examples illustrate the windows as drawn around two objects or images, the window can be drawn around fewer or additional objects or images, or a portion of one or more images. When the window 142 is drawn around the person 127 and clock 128, such objects of the person 127 and clock 128 may be dynamically rasterized and provided to the AI model as input. In some examples, such input may be buffered or otherwise temporarily stored for processing by the AI model while waiting for entry of input through a second mode.

As shown in FIG. 1C, the spatial interface 110 can be zoomed in or out. In the example of FIG. 1C, the spatial interface 110 is zoomed in, such that the objects or images in the spatial interface appear enlarged.

Also illustrated in FIG. 1C, window 143 may be drawn around only a portion of an image, such as to select a particular object within the image. For example, window 143 is shown as drawn around a front door and overhead sign portion of building 121. Accordingly, input to the AI model may be limited to the selected portion. In this regard, the processing by the AI model may focus on the particular object selected by window 143. For example, second input mode 150 may receive input such as “what would be a good logo for this sign?” or “where is this diner located?”. The AI model may process the input from the second mode along with the selected portion of the building 121 within the window 143 to provide a more specific response.

As shown in FIG. 1D, manipulating the spatial interface 110 can include panning the spatial interface 110. For example, as shown, the spatial interface 110 is moved upwards and to the right, such that positions of each respective object shown on the interface appear to have moved upwards and to the right. For example, car 125, person, and building 121 have a same relative position to each other and the other images in the spatial interface, but all the images have moved upwards and to the right. Some images that were previously visible in the field of view of the display, such as balloons 122 of FIG. 1A, are no longer visible in the field of view as a result of the panning. Similarly, some objects that were previously outside the field of view, such as star 124, bank 131, and car 132, are now visible as a result of the panning. It should be understood that panning may manipulate the interface 110 to move it in any direction and by any degree or distance, and such panning may be performed multiple times to move the spatial interface by a significant distance.

A shown in FIG. 1E, individual images or objects within the spatial interface 110 may be moved relative to other images or objects. For example, as shown, island 133 is moved closer to building 121. Similarly, person 127 and balloons 122 are moved downwards relative to clock 128. Multiple images or objects may be selected and moved together, or the objects or images may be moved individually.

In addition to moving objects or images, objects or images can be added or deleted. For example, images can be imported from storage, programs, applications, or the like. For example, images can be imported from browsers, photo storage, camera applications, etc.

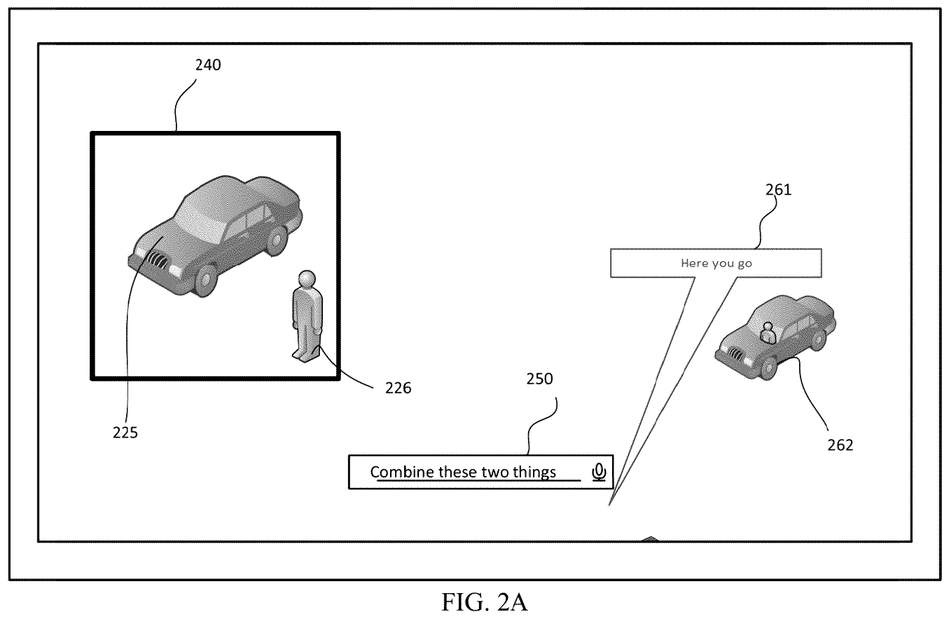

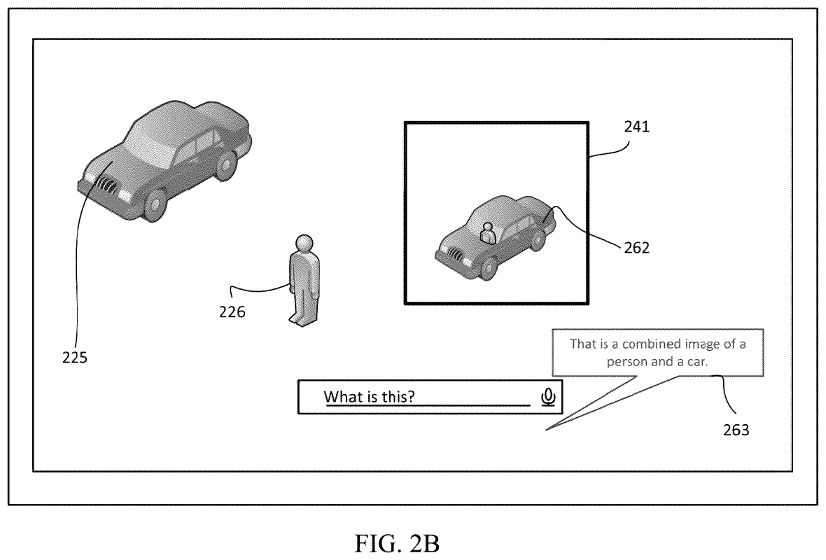

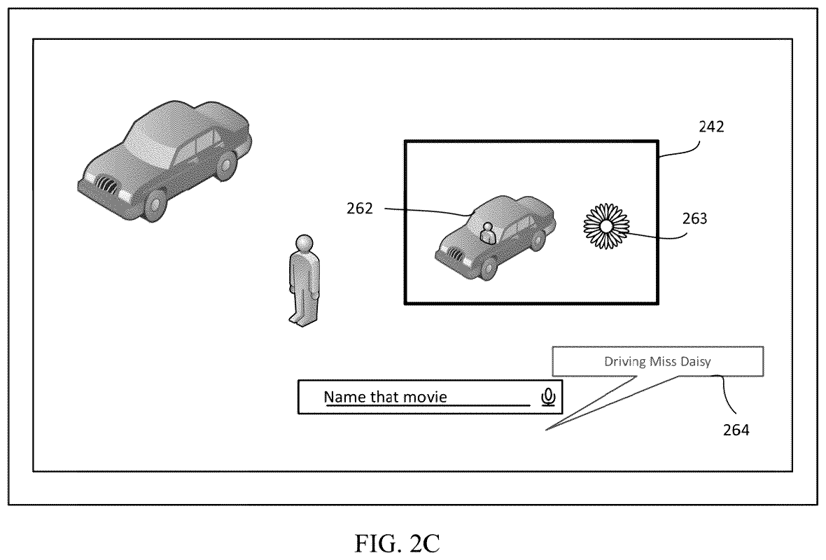

FIGS. 2A-2C illustrate examples of AI-generated responses to multi-modal input using the spatial interface. While the examples above illustrate merely a few examples of multi-modal queries or other input to the AI model, it should be understood that numerous other types of queries or input may be entered and processed by the AI model.

In the example of FIG. 2A, a first mode of input includes selection window 240, which is drawn around car 225 and person 226. A second mode of input includes text entry field 250, which receives a command to “combine these two things.” Both inputs are provided to the AI model, which recognizes “these two things” to refer to the two objects selected by the selection window 240. In response, the AI model may provide a combined image 262. The combined image 262 may be formed by the AI by detecting features of the objects, determining how such objects should be combined, and modifying the individual images and/or the combined image to combine them in a most appropriate way. In some examples, the AI model may additionally return a verbal or textual response 261, providing for a more interactive user experience.

The AI model may ingest both the textual and image inputs via a tokenization process, wherein each word and/or image portion is converted to a token that the AI model can process and use to create associations. The token may be, for example, a numerical value. An image may map to multiple tokens and a word may also map to multiple tokens depending on its length/complexity. Responses generated by the AI model may initially be in the form of tokens. Such response tokens are converted to their corresponding human-readable words and/or images.

In some examples, the AI model may dynamically combine the images as images are moved into the selection window. For example, the selection window may be formed around a first image, such as the car 225. The person 226 may be moved into the selection window also, such as by clicking and dragging the person 226 from a position outside the window to a position inside the window, where it is dropped. The AI model may detect, based on a query, based on placement of the person 226 as it is dragged and dropped with respect to the car 225, or based on any other criteria, that the user input intends for the images to be combined. Accordingly, the AI model may automatically and dynamically combine the images without further user input. Such inference and automatic/dynamic action may be applied to other types of spatial interface manipulation as well. For example, if the selection window was drawn around two separate images sequentially with queries to identify or translate a portion of the image, the AI model may infer that similar identification or translation is sought when the selection window is drawn around a third similar image within a predetermined period of time.

In the example of FIG. 2B, the AI model may receive as input the combined car/person image 262 via selection window 241. In response to a query such as “what is this” the AI model may decompose the combined image, and provide a response identifying the component parts of the combined image.

In the example of FIG. 2C, additional images or objects may be added to the selection window 242 along with the combined car/person image 262. For example, an image of a daisy 263 is added. The AI model may provide responses that require access to information outside of the spatial interface. For example, in response to the query “name that movie,” the AI model may determine a movie having relevance to most or all of the objects in the selection window 242. In this particular example, the AI model may provide a response 264 through the spatial interface identifying the movie as “Driving Miss Daisy.”

According to some examples, the input selected by the window or entered as text or verbal commands through the second input mode may be entered in any of a variety of languages. For example, the input may include text in English, French, Spanish, Mandarin, computer code languages, hieroglyphics, slang, or any other language. The AI model may detect the input language and provide responses in the same language. For example, if a user inputs a query in Spanish along with a selected window, the AI model may detect the input language and automatically provide the response in Spanish.

In other examples, the AI model may detect that the query seeks output in a different language. For example, the window may be formed around words in an image, such as on a street sign. The query may ask for a translation of the words in the image, such as “what does this say”. The AI model may detect, based on a first language in the selected portion of the image and a second language used to input the query, that the user seeks a translation of the text in the image from the first language to the second language. Accordingly, the AI model may translate the text selected in the image to the second language. Such output may be generated in the form of audio, text, or images through the spatial interface. According to some examples, the AI model may manipulate the images or portions of images selected in the window. For example, referring to the example above where text on an image of a street sign is selected as input, along with a request for translation, the AI model may provide as output a modified image showing the text on the street sign in the second language. In doing so, the AI model may detect characteristics of pixels within the image, such as colors, resolution, etc., and generate the translated image to have pixels with similar characteristics.

While the figures and description above provide a few examples of interactions with the AI model using the spatial interface, numerous other types of interactions are also possible. For example, the spatial interface may be used to enter input for playing games, such as charades, using the AI model. Other interactions may include visual riddles, identifying locations based on images, transforming images into code, creating different fashion outfits or decor aesthetics, coining terms, etc. By way of example, a visual riddle may include selecting a plurality of images or objects within the window and inputting a query for the AI model to guess the popular culture reference.

The AI model may be interactive, and may retain relevant portions of prior queries and responses in its analysis of subsequent queries. By way of example, subsequent to the query of “name that movie” and the response 264, a following query may ask “when did it come out” without again specifying the name of the movie. The AI model may retain response 264 as input which can be referenced in association with subsequent query to provide an appropriate response.

While the examples illustrate selection of images or objects within a window as a first mode of input, and entry of text or voice commands as a second mode of input, other types of input are possible. For example, a third input mode may include audio files, such as songs. A fourth input mode may include visual input, such as real-time camera footage. Any number of input modes may be provided to the AI model at a given time. For example, one, two, four, or any number of inputs may be provided to the AI model at a given time for processing in combination. In some examples, the spatial interface may provide for numerous different input modes, but not all of such input modes must be used for the AI model to generate an output. For example, the spatial interface may provide an option for entering three different modes of input, but may generate a response when only two modes of input are utilized.

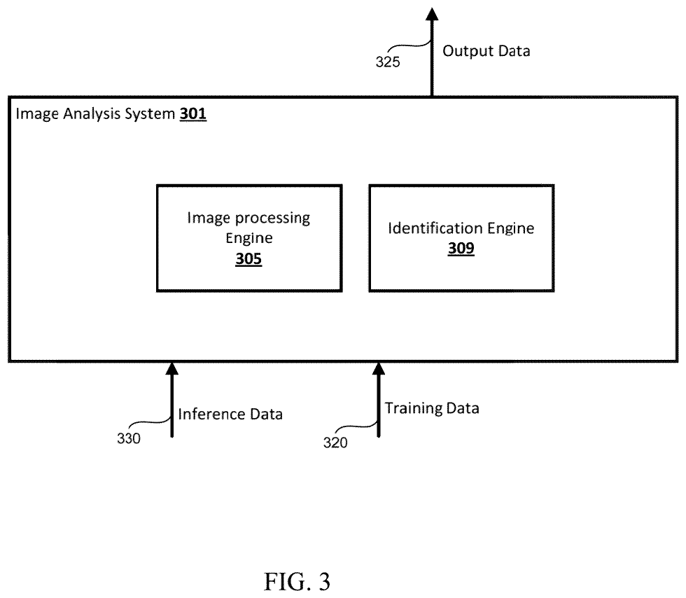

FIG. 3 depicts a block diagram of an example image analysis system 301, which can be implemented on one or more computing devices. The system 301 can be configured to receive inference data 330 and/or training data 320 for use in processing multi-dimensional visual input and generating responses according to a second input mode. For example, the system 301 can receive the inference data 330 and/or training data 320 as part of a call to an application programming interface (API) exposing the system 301 to one or more computing devices. Inference data 330 and/or training data 320 can also be provided to the system 301 through a storage medium, such as remote storage connected to the one or more computing devices over a network. Inference data 330 and/or training data 320 can further be provided as input through a user interface on a client computing device coupled to the system 301. The inference data 330 can include the selections of visual input using a selection window and entry of text or voice input using a second input mode.

The system 301 can include one or more engines, also referred to herein as modules and/or models, configured to process image data and identify particular objects within the processed image data. In this regard, system 301 includes image processing engine 305 and identification engine 309. The image processing engine 305 may be trained to process images, such as by rasterizing images, parsing images, combining multiple images, or otherwise changing an appearance of an image or metadata relating to an image. The identification engine 309 may be trained to determine particular objects within an image and associate the particular objects with other information. For example, the identification engine can identify a utility pole within an image, and determine that the image must have been taken in a specific geographic region based on the structure or type or arrangement of the utility pole.

Engines 305, 309 may be implemented as one or more computer programs, specially configured electronic circuitry or any combination thereof. Although FIG. 3 illustrates the system 301 as having two engines, the system 301 may have any number of engines. Moreover, the functionality of the engines described herein may be combined within one or more engines. Although engines 305, 309 are all shown as being in a single system 301, the engines may be implemented in more than one system.

Moreover, engines 305, 309 may work in tandem and/or cooperatively. For instance, the image processing engine 305 may provide outputs to the identification engine 309 for use generating responses to user queries.

The training data 320 can correspond to an artificial intelligence (AI) or machine learning (ML) task for identifying subsets of assets to include in personalized digital illustrations, determining characteristics and personalities of entities, generating video components, and other such tasks performed by engines 303-309. The training data 320 can be split into a training set, a validation set, and/or a testing set. An example training/validation/testing split can be an 80/10/10 split, although any other split may be possible.

The training data 320 can be in any form suitable for training an engine, according to one of a variety of different learning techniques. Learning techniques for training an engine can include supervised learning, unsupervised learning, and semi-supervised learning techniques. For example, the training data 320 can include multiple training examples that can be received as input by an engine.

The training examples can be labeled with a desired output for the engine when processing the labeled training examples.

The label and the engine output can be evaluated through a loss function to determine an error, which can be back propagated through the engine to update weights for the engine. For example, if the machine learning task is a classification task corresponding to determining characteristics of an entity, the training examples can be images labeled with one or more classes categorizing characteristics depicted in provided assets. As another example, a supervised learning technique can be applied to calculate an error between outputs, with a ground-truth label of a training example processed by the engine. Any of a variety of loss or error functions appropriate for the type of task the engine is being trained for can be utilized, such as cross-entropy loss for classification tasks, or mean square error for regression tasks. The gradient of the error with respect to the different weights of the candidate engine on candidate hardware can be calculated, for example using a backpropagation algorithm, and the weights for the engine can be updated. The engine can be trained until stopping criteria are met, such as a number of iterations for training, a maximum period of time, a convergence, or when a minimum accuracy threshold is met.

In addition to training data 320, having data available at inference time can also be beneficial to control or influence the output. Such data may include, for example, images selected using the window. These images may be processed, such as through labeling/captioning by image understanding machine learning models.

From the inference data 330 and/or training data 320, the system 301 can be configured to output one or more results related to the multi-mode input. As an example, the output data 325 can be any kind of image, audio, text, score, classification, or regression output based on the input data that is output by engines 305-309. Correspondingly, the AI or machine learning task can be a scoring, classification, and/or regression task for predicting some output given some input.

These AI or machine learning tasks can correspond to a variety of different applications in processing images, video, text, speech, or other types of data. The output data 325 can include instructions associated with these tasks, which can be executed by a computing device. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement the functionality described herein, for example, as performed by a system, engine, module, or model. The system 301 can further be configured to forward the output data to one or more other devices configured for translating the output data into an executable program written in a computer programming language. The system 301 can also be configured to send the output data to a storage device for storage and later retrieval. Additionally, or alternatively, the asset creation tool may be configured to receive the output of the system 301 for further processing and/or implementation.

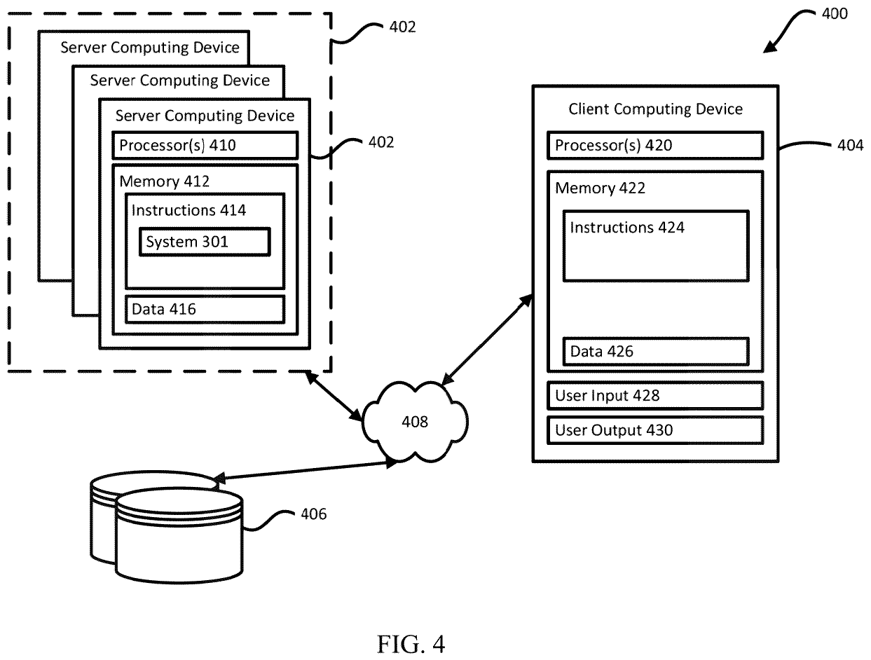

FIG. 4 depicts a block diagram of an example environment 400 for implementing the systems and applications described herein such as the image analysis system 301. The system 400 can be implemented on one or more computing devices having one or more processors in one or more locations, such as in server computing device 402 and client computing device 404. Client computing device 404 and the server computing device 402 can be communicatively coupled to one or more storage devices 406 over a network 408. The storage device 406 can be a combination of volatile and non-volatile memory and can be at the same or different physical locations than the computing devices 402, 404. For example, the storage devices 406 can include any type of non-transitory computer readable medium capable of storing information, such as a hard-drive, solid state drive, tape drive, optical storage, memory card, ROM, RAM, DVD, CD-ROM, write-capable, and read-only memories. The storage device 406 may store assets, video components, and other data discussed herein.

The server computing device 402 can include one or more processors 410 and memory 412. The memory 412 can store information accessible by the processors 410, including instructions 414 that can be executed by the processors 410. The memory 412 can also include data 416 that can be retrieved, manipulated, or stored by the processors 410. The memory 412 can be a type of non-transitory computer readable medium capable of storing information accessible by the processors 410, such as volatile and non-volatile memory. The processors 410 can include one or more central processing units (CPUs), graphic processing units (GPUs), field-programmable gate arrays (FPGAs), and/or application-specific integrated circuits (ASICs), such as tensor processing units (TPUs).

The instructions 414 can include one or more instructions that, when executed by the processors 410, cause the one or more processors to perform actions defined by the instructions 414. The instructions 414 can be stored in object code format for direct processing by the processors 410, or in other formats including interpretable scripts or collections of independent source code modules that are interpreted on demand or compiled in advance. Instructions 414 can include instructions for implementing a personalized digital illustration generation system 301. The system 301 can be executed using the processors 410, and/or using other processors remotely located from the server computing device 402. Although the system 301 is shown as being executed by server computing device 402, the system 301 can be executed by a client computing device, such as client computing device 404.

The data 416 can be retrieved, stored, or modified by the processors 410 in accordance with the instructions 414. The data 416 can be stored in computer registers, in a relational or non-relational database as a table having a plurality of different fields and records, or as JSON, YAML, or XML documents. The data 416 can also be formatted in a computer-readable format such as, but not limited to, binary values, ASCII, or Unicode. Moreover, the data 416 can include information sufficient to identify relevant information, such as numbers, descriptive text, proprietary codes, pointers, references to data stored in other memories, including other network locations, or information that is used by a function to calculate relevant data. For instance, the data may include training data, inference data, illustrations, assets, etc.

The client computing device 404 can be configured similarly to the server computing device 402, with one or more processors 420, memory 422, instructions 424 (such as the enterprise application, which may additionally or alternatively, be executed by the server computing device 402), and data 426. The client computing device 404 can also include a user input 428 and a user output 430. The user input 428 can include any appropriate mechanism or technique for receiving input from a user, such as keyboard, mouse, mechanical actuators, soft actuators, touchscreens, microphones, and sensors.

The server computing device 402 and client computing device 404 can be configured to transmit and receive data to and from each other device. In some instances, the client computing device 404 can be configured to display at least a portion of the received data from the server computing device 402, on a display implemented as part of the user output 430. The user output 430 can also be used for displaying an interface between the client computing device 404 and the server computing device 402. The user output 430 can alternatively or additionally include one or more speakers, transducers, or other audio outputs, a haptic interface or other tactile feedback that provides non-visual and non-audible information to the platform user of the client computing device 404.

Although FIG. 4 illustrates the processors 410, 420 and the memories 412, 422 as being within the computing devices 402, 404, components described herein can include multiple processors and memories that can operate in different physical locations and not within the same computing device. For example, some of the instructions 414, 424 and the data 416, 426 can be stored on a removable SD card and others within a read-only computer chip. Some or all of the instructions and data can be stored in a location physically remote from, yet still accessible by, the processors 410, 420. Similarly, the processors 410, 420 can include a collection of processors that can perform concurrent and/or sequential operation. The computing devices 402, 404 can each include one or more internal clocks providing timing information, which can be used for time measurement for operations and programs run by the computing devices 402, 404.

The server computing device 402 can be connected over the network 408 to a datacenter (not shown) housing any number of hardware accelerators. The datacenter can be one of multiple datacenters or other facilities in which various types of computing devices, such as hardware accelerators, are located. Computing resources housed in the datacenter can be specified for deploying models, such as the engines described herein.

The server computing device 402 can be configured to receive requests to process data from the client computing device 404 on computing resources in the datacenter. For example, the environment 400 can be part of a computing platform configured to provide a variety of services to users, through various user interfaces and/or application programming interfaces (APIs) exposing the platform services. The variety of services can include providing a spatial interface for multi-modal input to AI models, and generating responses to the multi-modal input using AI. In one example, the client computing device 404 can transmit data specifying requests for services. The server computing system 402 can receive the request, and in response, use the system 301 to generate a response.

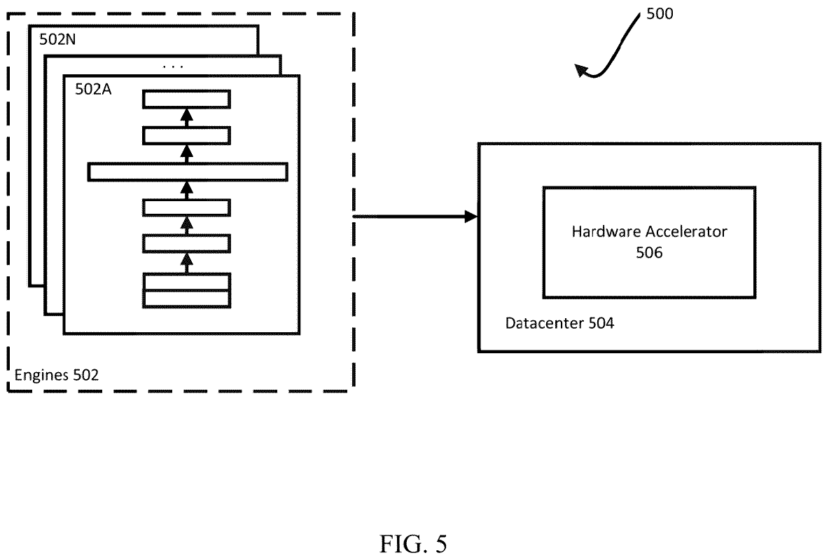

FIG. 5 depicts a block diagram 500 illustrating one or more engine architectures 502, more specifically 502A-N for each architecture, for deployment in a datacenter 504 housing a hardware accelerator 506 on which the deployed engines 502 will execute. The hardware accelerator 506 can be any type of processor, such as a CPU, GPU, FPGA, or ASIC such as a TPU.

An architecture 502 of an engine can refer to characteristics defining the engine, such as characteristics of layers for the models, how the layers process input, or how the layers interact with one another. The architecture 502 of the engine can also define types of operations performed within each layer. One or more architectures 502 can be generated that can output results.

Referring back to FIG. 4, the computing devices 402, 404, and the datacenter can be capable of direct and indirect communication over the network 408. For example, using a network socket, the client computing device 404 can connect to a service operating in the datacenter through an Internet protocol. The computing devices 402, 404 can set up listening sockets that may accept an initiating connection for sending and receiving information. The network 508 itself can include various configurations and protocols including the Internet, World Wide Web, intranets, virtual private networks, wide area networks, local networks, and private networks using communication protocols proprietary to one or more companies. The network 508 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 408, in addition or alternatively, can also support wired connections between the computing devices 402, 404 and the datacenter, including over various types of Ethernet connections.

Although a single client computing device 404 is shown in FIG. 4, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing engines, and any combination thereof.

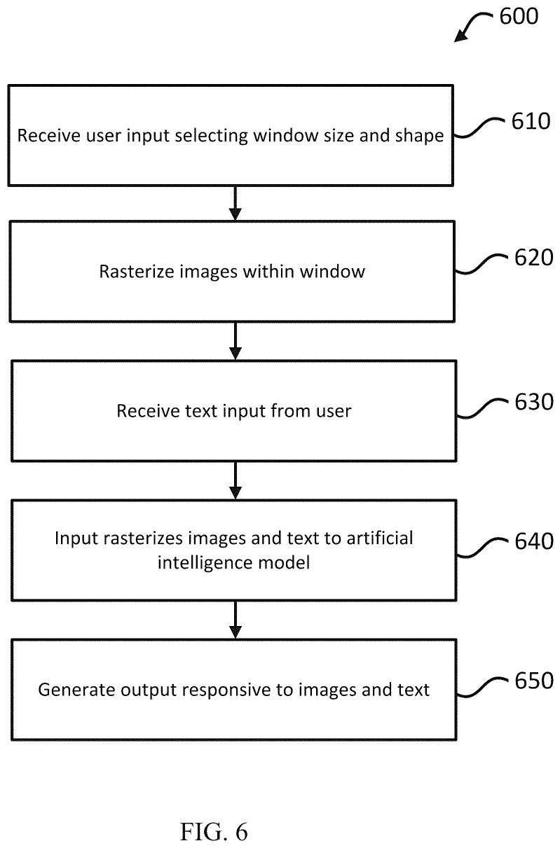

FIG. 6 illustrates a method 600 for receiving multi-modal input to an AI model through a spatial interface, and generating a response through the interface using the AI model. The method may be performed by one or more processors, and may implement one or more AI or ML models. While operations of the method 600 are described in a particular order, it should be understood that operations may be performed in a different order or simultaneously. Moreover, operations may be added or omitted.

In block 610, user input is received through the spatial interface. The spatial interface may display a first offering of objects, such as images, videos, text, icons representing audio files, or any other types of objects. The user input may include selecting a window size and shape in relation to one or more objects of the first offering, such as to encompass the one or more objects within the window. For example, selecting the window size and shape may include a click-and-drag or other operation to move or resize a box or other window shape. The spatial interface may be manipulated so as to display a different offering of objects than the first offering. For example, manipulation input may be received causing the spatial interface to pan or zoom, thereby revealing a different offering of objects. Moreover, user input may be received to adjust a location of individual objects. For example, a first object may be moved closer to a second object, such as to facilitate selection of both the first and second object within the same window. In some examples, the user input may include selection of multiple objects using multiple windows. For example, a first object displayed at a first portion of the spatial interface can be selected using a first window, while a second object at a second portion of the interface may be selected using a second window. Similarly, the first and second objects may be selected using other types of selection mechanisms other than resizable windows, such as clicking, highlighting, dragging to a specified portion of the interface, etc.

In block 620, the selected objects, such as those encompassed within the window, may be flattened or rasterized. For example, vector data associated with the objects may be converted to a grid of pixels.

In block 630, a second mode of input may be received from the user. The second mode of input may be, for example, textual or verbal input received through the spatial interface. In other examples, the second mode of input can be separate from the spatial interface. The second mode of input may relate to the objects encompassed within the window. For example, the second mode of input may include a question, instruction, or other prompt related to the one or more objects in the window.

In block 640, the flattened image within the window and the input from the second mode are input to an AI model. For example, the flattened image and the second mode of input may be input to the model as a combined input.

In block 650, the AI model generates a response that considers both the images from the window and the second mode of input. For example, the AI model may determine a relationship between the one or more objects and the second mode of input. Such response may be output to the user through the spatial interface.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on it software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as a TensorFlow framework, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a stand-alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purposes logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back-end component, e.g., as a data server, a middleware component, e.g., an application server, or a front-end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method, comprising:
receiving, at one or more processors through a spatial interface displaying a first offering of objects, user input selecting a window size and shape, such that the window encompasses one or more objects depicted on the spatial interface;
receiving, at the one or more processors, a second mode of input;
providing the one or more objects and the second mode of input as a combined input to an artificial intelligence model;
determining, by the artificial intelligence model, at least one relationship between the one or more objects and the second mode of input; and
generating, by the artificial intelligence model, a response based on the at least one relationship.

2. The method of claim 1, comprising outputting the response visually through the spatial interface.

3. The method of claim 1, wherein the one or more objects comprise a first object of a first type and a second object of a second type different from the first type.

4. The method of claim 3, wherein the first object comprises an image.

5. The method of claim 1, further comprising rasterizing the one or more objects encompassed in the window.

6. The method of claim 1, wherein the second mode of input comprises text or verbal input.

7. The method of claim 1, wherein the second mode of input is received through the spatial interface.

8. The method of claim 1, wherein the second mode of input is received through a second interface separate from the spatial interface.

9. The method of claim 1, wherein the window encompasses multiple objects, and wherein determining the at least one relationship comprises identifying a relationship among the multiple objects.

10. The method of claim 1, further comprising:
receiving through the spatial interface a manipulation input; and
adjusting, by the one or more processors, the spatial interface in response to the manipulation input, the adjusting comprising panning or zooming the spatial interface to display a second offering of objects different from the first offering of objects.

11. The method of claim 1, further comprising receiving input adjusting a location of a first object of the first offering of objects relative to a second object of the first offering of objects.

12. The method of claim 1, further comprising adding an object to the first offering of objects.

13. A system, comprising:
memory; and
one or more processors in communication with the memory, the one or more processors configured to:
receive, through a spatial interface displaying a first offering of objects, user input selecting a window size and shape, such that the window encompasses one or more objects depicted on the spatial interface;
receive a second mode of input;
provide the one or more objects and the second mode of input as a combined input to an artificial intelligence model;
determine, using the artificial intelligence model, at least one relationship between the one or more objects and the second mode of input; and
generate, using the artificial intelligence model, a response based on the at least one relationship.

14. The system of claim 13, wherein the one or more processors are configured to output the response visually through the spatial interface.

15. The system of claim 13, wherein the one or more objects comprise at least one image.

16. The system of claim 15, wherein the one or more processors are configured to rasterize the one or more objects encompassed in the window.

17. The system of claim 13, wherein the second mode of input comprises text or verbal input.

18. The system of claim 13, wherein the window encompasses multiple objects, and wherein determining the at least one relationship comprises identifying a relationship among the multiple objects.

19. The system of claim 13, wherein the one or more processors are further configured to:
receive through the spatial interface a manipulation input; and
adjust the spatial interface in response to the manipulation input, the adjusting comprising panning or zooming the spatial interface to display a second offering of objects different from the first offering of objects.

20. A non-transitory computer-readable medium storing instructions executable by one or more processors for performing a method, comprising:
receiving, through a spatial interface displaying a first offering of objects, user input selecting a window size and shape, such that the window encompasses one or more objects depicted on the spatial interface;
receiving a second mode of input;
providing the one or more objects and the second mode of input as a combined input to an artificial intelligence model;
determining, by the artificial intelligence model, at least one relationship between the one or more objects and the second mode of input; and
generating, by the artificial intelligence model, a response based on the at least one relationship.
